(19) United States
(12) Patent Application Publication
(10) Pub. No.: US 2026/0180868 A1
(43) Pub. Date: Jun. 25, 2026

(54) VIRTUAL CLOUD SIMULATION WITHIN PUBLIC CLOUD NETWORK

(71) Applicant: Microsoft Technology Licensing, LLC, Redmond, WA (US)

(72) Inventors: George KIM, Fairfax, VA (US); Patrick Wayne GHEE, Rockville, MD (US); Andrew SOLLISH, Sammamish, WA (US)

(73) Assignee: Microsoft Technology Licensing, LLC, Redmond, WA (US)

(21) Appl. No.: 18/989,364

(22) Filed: Dec. 20, 2024

(51) Int. Cl. H04L 41/14

(52) U.S. Cl. CPC H04L 41/145

(57) ABSTRACT

Systems and methods are provided for implementing virtual cloud simulation within a public cloud network. In examples, a domain name system (“DNS”) server in a virtual cloud network receives, from a service under test that is running within the virtual cloud network, a request to access a resource, the request including non-routable cloud configurations for the resource. A central configuration repository in the virtual cloud network maps the non-routable cloud configurations for the resource that are identified in the request from the service under test to public cloud configurations of the resource. A reverse proxy server in the virtual cloud network directs the request to a public cloud instance of the resource that is running in another portion of the public cloud network, directs return data traffic from the public cloud instance of the resource back to the service under test in the virtual cloud network.

### BACKGROUND

Deploying a new cloud network or environment is a time consuming, resource-heavy endeavor, and testing applications within such environments can present complications. It is with respect to this general technical environment to which aspects of the present disclosure are directed. In addition, although relatively specific problems have been discussed, it should be understood that the examples should not be limited to solving the specific problems identified in the background.

### SUMMARY

This summary is provided to introduce a selection of concepts in a simplified form that are further described below in the detailed description section. This summary is not intended to identify key features or essential features of the claimed subject matter, nor is it intended as an aid in determining the scope of the claimed subject matter.

The currently disclosed technology, among other things, provides for virtual cloud simulation within a public cloud network. In examples, a domain name system (“DNS”) server in a virtual cloud network receives, from a service under test that is running within the virtual cloud network, a request to access a resource, the request including non-routable cloud configurations for the resource. A central configuration repository in the virtual cloud network maps the non-routable cloud configurations for the resource that are identified in the request from the service under test to public cloud configurations of the resource. A reverse proxy server in the virtual cloud network directs the request to a public cloud instance of the resource that is running in another portion of the public cloud network, directs return data traffic from the public cloud instance of the resource back to the service under test in the virtual cloud network.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing virtual cloud simulation within a public cloud network.

FIG. 2 depicts an example system for implementing virtual cloud simulation within another cloud network.

FIG. 3 depicts an example method for implementing virtual cloud simulation within a public cloud network.

FIG. 4 depicts an example method for implementing virtual cloud simulation within another cloud network.

FIG. 5 depicts a block diagram illustrating example physical components of a computing device with which aspects of the technology may be practiced.

### DETAILED DESCRIPTION OF CERTAIN EMBODIMENTS

As briefly discussed above, deploying a new cloud network or environment is a time consuming, resource-heavy endeavor, and testing applications within such environments can present complications. For example, conventionally, applications being launched can only be tested within the launched cloud network for which it is designed, which can lead to errors due to incorrect configuration settings or other interoperability issues. In some cases, the interoperability issues can lead to outages of portions or an entirety of the cloud network. Especially for sovereign cloud networks or secure cloud networks, such outages can be problematic, costly, and can in some cases lead to security issues with respect to data and services within such cloud environments.

The present technology provides for virtual cloud simulation within a public cloud network, and, in some cases, for virtual cloud simulation within another cloud network. In examples, a cloud simulation system enables resolution and proxying of configuration values from some cloud environments, such as non-routable or under-development cloud environments, to other cloud environments, such as public cloud environments or already-established cloud environments. The cloud simulation system facilitates interoperability testing within simulated contexts, enabling verification of configuration values against dynamic environments supported by actual cloud resources. By doing so, the cloud simulation system boosts the certainty and reliability of deployments and operations in these settings. Additionally, the cloud simulation system helps avert costly outages by identifying and notifying service owners of incorrect configurations prior to full production rollout, thereby enhancing cloud service availability and dependability. In multi-cloud scenarios, the cloud simulation system can simulate an air-gapped environment, creating a virtual cloud network, which allows services to be deployed and tested in one cloud environment while using resources from another, effectively creating a digital twin of one cloud on (or effectively mapping a cloud within the resource topology of) an existing cloud platform. For instance, a service destined for cloud B can be validated by deploying it in cloud A. The cloud simulation system shares characteristics with both DNS and proxies but stands apart from forward proxies, which act on behalf of clients, and reverse proxies, which act on behalf of servers. In this manner, the cloud simulation system functions transparently without being directly recognized by clients and servers. Further, the cloud simulation system decreases the probability of outages from incorrect configuration values and allows independent validation of configurations without the need for dedicated test suites to be created, while allowing for interfacing with other services in a virtual setting. This will also help in the preparation of buildout of new regions and new cloud environments before those regions and cloud environments are physically built, thus decreasing time to market for the application and/or the new cloud environment.

Various modifications and additions can be made to the embodiments discussed herein without departing from the scope of the disclosed techniques. For example, while the embodiments described above refer to particular features, the scope of the disclosed techniques also includes embodiments having different combinations of features and embodiments that do not include all of the above-described features.

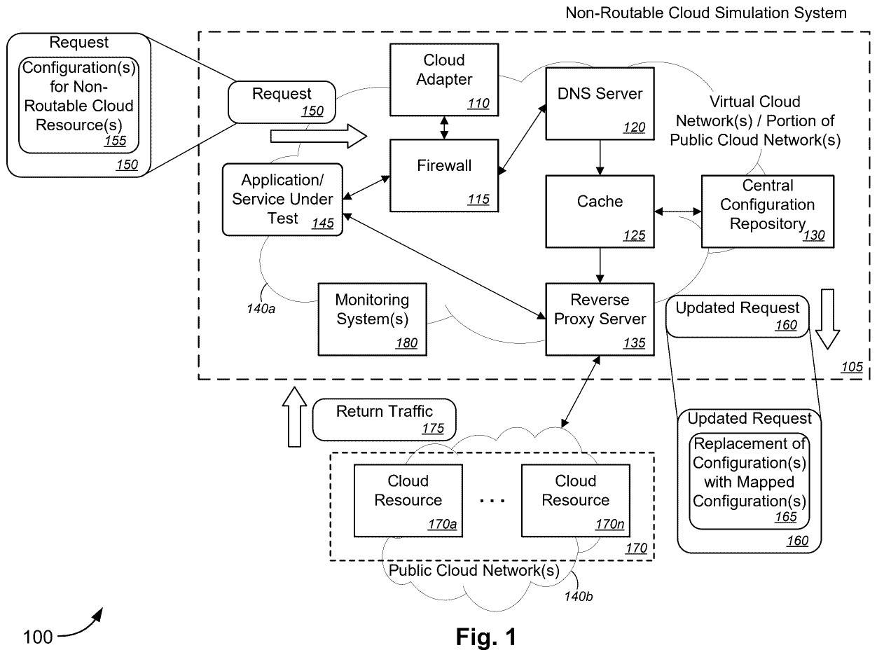

Turning to the embodiments as illustrated by the drawings, FIGS. 1-5 illustrate some of the features of methods, systems, and apparatuses for implementing virtual cloud simulation within a public cloud network, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

FIG. 1 depicts an example system 100 for implementing virtual cloud simulation within a public cloud network. System 100 includes a non-routable cloud simulation system 105. In some examples, the non-routable cloud simulation system 105 includes a cloud adapter 110, a firewall 115, a DNS server 120, a cache 125, a central configuration repository 130, and a reverse proxy server 135, each disposed within a virtual cloud network(s) or a portion of a public cloud network(s) 140a. An application (or service under test) 145 is tested within the virtual cloud network(s) 140a, which simulates a non-routable cloud network(s) for the application 145. That is, from the perspective of the application 145, the application 145 is running within the non-routable cloud network(s) and communicates with only applications, services, and resources that are hosted within the non-routable cloud network(s). In some examples, the non-routable cloud network being simulated is one of a sovereign cloud network, a secure cloud network, a private cloud network, or an on-premises enclave, each of which is isolated from the public cloud network, public resources, and the Internet.

To achieve this effect (i.e., to simulate the virtual cloud network within another cloud network, while not disrupting such a perspective of the application 145), the DNS server 120 causes all data traffic from the application 145 that is running within the virtual cloud network(s) 140a to be routed to the DNS server 120. In some cases, the firewall 115 monitors the data traffic from the application 145 (including requests for one or more resources) and further directs the data traffic from the application 145 to the DNS server 120. In some instances, the cloud adapter 110 implements protocols for configuring the portion of the public cloud network(s) 140a to function as a virtual cloud network(s) and/or for configuring the firewall 115 to perform functions of the virtual cloud network(s). The central configuration repository 130 maps non-routable cloud configurations of a resource (e.g., cloud configurations of the resource that are identified in data traffic such as a request that is received from the application 145) to public cloud configurations of the resource. The reverse proxy server 135 directs the data traffic to the resource based on the configuration mappings provided by the central configuration repository 130. The cache 125 (such as a remote dictionary server or Redis cache, which is a non-relational data store that is used primarily as an application cache or a quick-response database, or other cache) stores the configuration mappings retrieved from the central configuration repository 130, and provides the reverse proxy server 135 with the configuration mappings.

In some examples, the resource (e.g., cloud resource 170 of cloud resources 170a-170n in public cloud network(s) 140b) includes one of a cloud storage resource, a multi-model database resource, a relational database resource, a non-relational database resource, a secrets storage resource, a monitoring service, an applications insights resource, a log analytics resource, a message queue resource, a communication resource, a website resource, a networking resource, or other cloud-based resource or service. The cloud storage resource provides cloud-based data storage services, such as storing data objects in a high availability, massively scalable, durable, and secure storage system in a cloud network. The multi-model database resource, which in some cases includes a non-relational and vector database that is capable of handling storage and access of unstructured, semi-structured, structured, and/or vector data types, is a high availability, scalable, and low-latency database. The relational database resource stores data that is organized into interrelated tables, and, in some cases, uses structured query language (“SQL”) for querying the stored data. The non-relational database resource is capable of storing data in a non-structured manner, and in some cases is capable of storing unstructured, semi-structured, and/or structured data types. A secrets storage resource encrypts and stores keys (e.g., public, private, and/or symmetric keys or other cryptographic keys), secrets (e.g., passwords, data, and/or metadata). A monitoring service monitors interactions between an application or service under test (such as application 145) and other components of the network (in this case, routers, switches, or other equipment of networks 140a and 140b), collects or compiles telemetry data based on the monitored interactions, and provides the telemetry data for requesting devices. An applications insights resource is a type of monitoring service that analyzes the telemetry data associated with interactions between an application or service under test (such as application 145) and other components of the network (in this case, routers, switches, or other equipment of networks 140a and 140b), and provides insights, metrics, summaries, and/or trend-based information to the requesting devices. A log analytics resource analyzes log data associated with log events triggered by an application or service under test (such as application 145), and provides analytics data regarding the log data to the requesting devices. A message queue resource stores messages or packets of data until the messages or packets data are processed either after being received or for transmitting. A communication resource is a type of network infrastructure (e.g., optical fiber communications infrastructure, cellular communications infrastructure, or satellite communications infrastructure) that is used for transmitting data. A website resource is an identifiable resource that is either created during development of a web application or otherwise accessible by the web application, and includes webpages, files, libraries, and/or other documents. A networking resource is a physical or logical component that is used in storage, processing, aggregation, and routing within a network, and includes memory, power source, bandwidth, and algorithms.

As used herein, a cloud network refers to a global network of servers or a vast network of remote servers that are connected together to operate as a single ecosystem. A non-routable cloud network, as used herein, refers to a cloud network that is isolated from external networks, such as public cloud networks, public resources, and/or the Internet. As used herein, a sovereign cloud network refers to a cloud computing environment that stores data and metadata for one or more organizations or entities on servers located within a local country of the one or more organizations or entities, and that protects the data and metadata from access by foreign entities. A secure cloud network, as used herein, refers to a cloud network containing secret data (such as secret or proprietary data) and that implements security measures (such as air gap networking, encryption, etc.) to prevent access of the secret data by unauthorized entities external to the secure cloud network. As used herein, an on-premises enclave refers to an execution environment (in this case, that is within a customer premises) that prevents code or applications external to the execution environment from accessing data within the execution environment, allowing only code or applications running within the execution environment to access the data within the same execution environment.

In operation, the application 145 sends a request 150 to access a resource, the request 150 including configurations for non-routable cloud resources within a non-routable cloud network, in which the application 145 is configured to operate within. In an example, the request 150 is routed through firewall 115, which directs the request 150 to the DNS server 120. In another example, the request 150 is routed to the DNS server 120 without being routed through the firewall 115. The DNS server 120 receives the request 150, and, in some cases, causes the central configuration repository 130 to map non-routable cloud configurations of the resource that is identified in the request 150 from the application 145 to public cloud configurations of the resource. In examples, each of the non-routable cloud configurations and the public cloud configurations include a set of configurations including at least one of domain name configuration, client identifier configuration, subscription identifier configuration, subject name configuration, subject certificate configuration, subject alternate name configuration, parity flag configuration, cloud region identifier configuration, resource type identifier configuration, tenant identifier configuration, or virtual machine (“VM”) capacity stock keeping unit (“SKU”) configuration. In some cases, the configuration mappings for the resource from the central configuration repository 130 are stored in cache 125. The reverse proxy server 135 directs an updated request 160, which includes the public cloud configurations 165 of the resource based on the configuration mappings for the resource (either obtained directly from the central configuration repository 130 or obtained from the cache 125), to the resource disposed in the public cloud network(s) 140b (e.g., one of cloud resources 170a-170n). The reverse proxy server 135 directs return traffic 175 from the resource 170 in the public cloud network(s) 140b to the application 145 in the virtual cloud network(s) 140a.

In some examples, system 100 further includes a monitoring system(s) 180, which includes at least one of a passive monitoring system or an active monitoring system disposed within the portion of the public cloud network. The at least one of the passive monitoring system or the active monitoring system collects and sends telemetry data to the application 145 in the portion of the public cloud network. This enables the application 145 to verify its configuration values for interoperability testing within the virtual cloud network, simulating the non-routable cloud network. Information obtained based on the telemetry data can be used to adjust the configuration values to improve interoperability and to vet the settings for the application 145 within the virtual cloud network, prior to the application 145 being deployed in a physically built-out non-routable cloud environment.

In the manner as described above, rather than building a dedicated cloud network to run and test the application 145, which requires expending of significant resources to establish a non-routable cloud network (such as one that features air-gapping to prevent unchecked transfer of data traffic to and from the non-routable cloud network) (as discussed above), the non-routable cloud simulation system 105 simulates the non-routable cloud network as a virtual cloud network within a portion of the public cloud network. As further described above, interoperability testing within simulated contexts is facilitated, while enabling verification of configuration values against dynamic environments supported by actual cloud resources. Certainty and reliability of deployments and operations in these settings are also boosted. Additionally, the non-routable cloud simulation system 105 averts costly outages by enabling identification and notifying service owners of incorrect configurations prior to full production rollout, thereby enhancing cloud service availability and dependability. That is, the probability of outages from incorrect configuration values is dramatically decreased. Independent validation of configurations can be achieved without the need to create dedicated test suites while allowing interface of the application under test in a virtual setting. This assists teams in preparing to buildout new regions and clouds before those regions are physically built, thus decreasing time to market. For multi-cloud scenarios, the non-routable cloud simulation system 105 can simulate an air-gapped environment, enabling services to be deployed and tested in one cloud environment while using resources from another cloud environment, effectively creating a digital twin of one cloud on an existing cloud platform. The simulation of the virtual cloud network avoids the standup and purchasing of physical hardware to mimic real world capabilities.

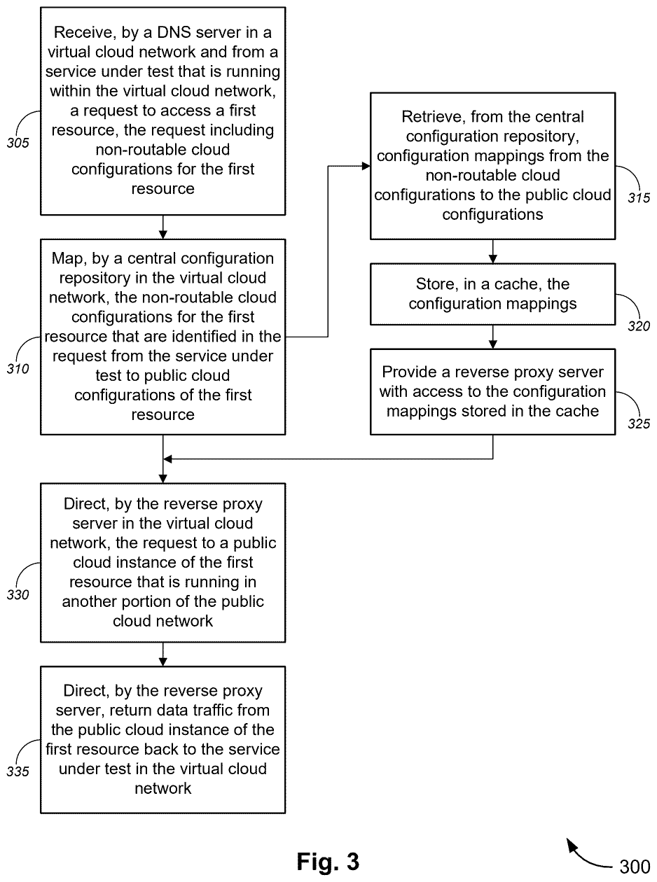

In operation, non-routable cloud simulation system 105 and/or its components may perform methods for implementing virtual cloud simulation within a public cloud network, as described in detail with respect to method 300 of FIG. 3, and method 300 as described below with respect to FIG. 3 may be applied with respect to the operations of system 100 of FIG. 1.

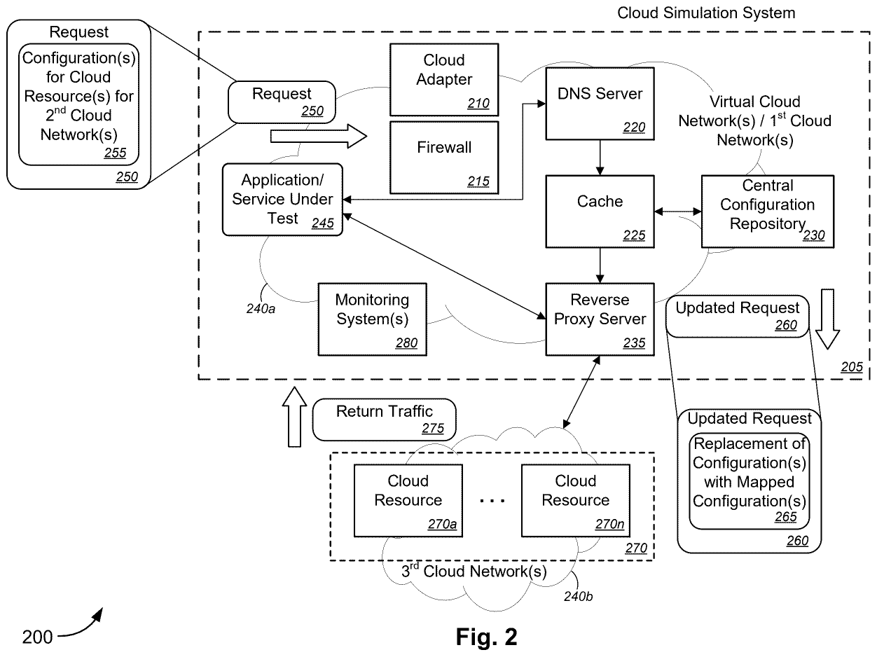

FIG. 2 depicts an example system 200 for implementing virtual cloud simulation within another cloud network. In some embodiments, cloud simulation system 205, cloud adapter 210, firewall 215, DNS server 220, cache 225, central configuration repository 230, reverse proxy server 235, virtual cloud network(s) or first cloud network(s) 240a, third cloud network 240b, application or service under test 245, request 250, configurations for cloud resource(s) for a second cloud network(s) 255, updated request 260, replacement configuration(s) with mapped configuration(s) 265, cloud resource(s) 270 or 270a-270n, return traffic 275, and monitoring system(s) 280 of FIG. 2 may be similar, if not identical, to the non-routable cloud simulation system 105, cloud adapter 110, firewall 115, DNS server 120, cache 125, central configuration repository 130, reverse proxy server 135, virtual cloud network(s) or the portion of the public cloud network(s) 140a, the public cloud network 140b, application or service under test 145, request 150, configurations for non-routable cloud resource(s) 155, updated request 160, replacement configuration(s) with mapped configuration(s) 165, cloud resource(s) 170 or 170a-170n, return traffic 175, and monitoring system(s) 180, respectively, of system 100 of FIG. 1, and the description of these components of system 100 of FIG. 1 are similarly applicable to the corresponding components of FIG. 2.

Where example 100 of FIG. 1 is directed to simulation of a non-routable cloud network as a virtual cloud network within a portion of a public cloud network, example 200 of FIG. 2 is more broadly directed to simulation of any suitable cloud network as a virtual cloud network within another cloud network. In this manner, the virtual cloud network need not only simulates non-routable cloud environments, but can be used to simulate any suitable cloud environment without first having to buildout that cloud environment. Accordingly, configuration values of an application or service under test (e.g., application 245) can be tested, verified, and changed prior to launching the application in the desired cloud environment, and, in some cases, prior to building and establishing the desired cloud environment. In some instances, testing within the desired cloud environment may be limited due to system constraints (such as with non-routable cloud networks being limited to interacting only within the cloud environment) or due to time constraints (such as with tight windows for launching the cloud environment, which may limit amount of time for testing applications being launched within the cloud environment). System 200 of FIG. 2 would otherwise operate in a similar manner as system 100 of FIG. 1.

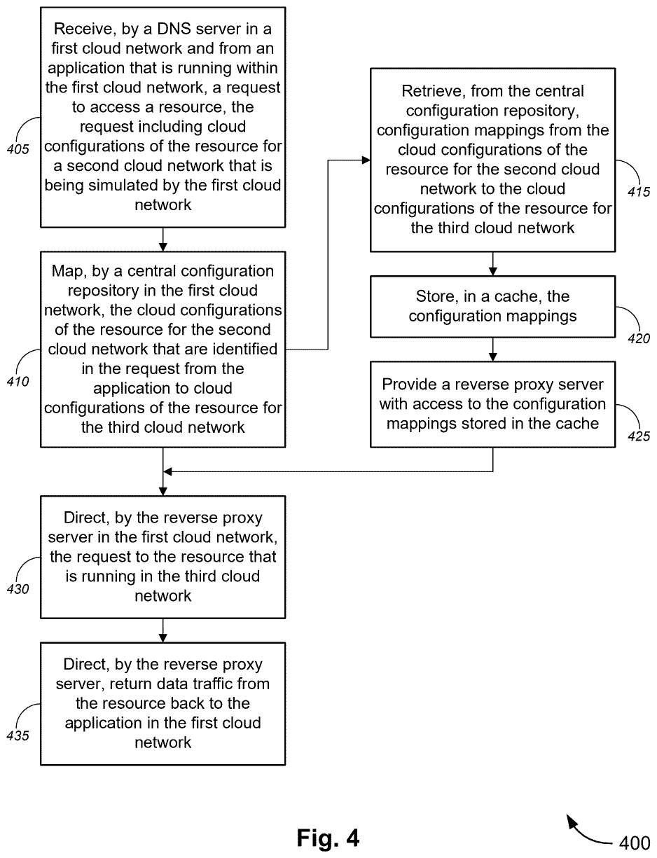

In operation, cloud simulation system 205 and/or its components may perform methods for implementing virtual cloud simulation within another cloud network, as described in detail with respect to method 400 of FIG. 4, and method 400 as described below with respect to FIG. 4 may be applied with respect to the operations of system 200 of FIG. 2.

FIG. 3 depicts an example method 300 for implementing virtual cloud simulation within a public cloud network. In examples, the operations of example method 300 may be performed by a non-routable cloud simulation system (e.g., a non-routable cloud simulation system 105 of FIG. 1).

In the example method 300 of FIG. 3, at operation 305, a DNS server (e.g., DNS server 120 of FIG. 1) of a non-routable cloud simulation system in a virtual cloud network (e.g., virtual cloud network(s) or portion of public cloud network(s) 140a of FIG. 1) receives a request to access a first resource from a service under test (e.g., application or service under test 145 of FIG. 1) that is running within the virtual cloud network. The virtual cloud network is a portion of a public cloud network or is a cloud network sharing properties and characteristics with the public cloud network. In examples, the request includes non-routable cloud configurations for the first resource. In some instances, the virtual cloud network simulates a non-routable cloud network including one of a sovereign cloud network, a secure cloud network, a private cloud network, or an on-premises enclave, each of which is isolated from the public cloud network, public resources, and the Internet. In some examples, the first resource includes one of a cloud storage resource, a multi-model database resource, a relational database resource, a non-relational database resource, a secrets storage resource, a monitoring service, an applications insights resource, a log analytics resource, a message queue resource, a communication resource, a website resource, or a networking resource.

At operation 310, a central configuration repository (e.g., central configuration repository 130 of FIG. 1) of the non-routable cloud simulation system, in the virtual cloud network, maps the non-routable cloud configurations of the first resource that are identified in the request from the service under test to public cloud configurations of the first resource. In examples, each of the non-routable cloud configurations and the public cloud configurations include a set of configurations including at least one of domain name configuration, client identifier configuration, subscription identifier configuration, subject name configuration, subject certificate configuration, subject alternate name configuration, parity flag configuration, cloud region identifier configuration, resource type identifier configuration, tenant identifier configuration, or VM capacity SKU configuration. Method 300 either continues onto the process at operation 315 or continues onto the process at operation 330.

At operation 315, the non-routable cloud simulation system retrieves, from the central configuration repository, configuration mappings from the non-routable cloud configurations to the public cloud configurations. At operation 320, the non-routable cloud simulation system stores the configuration mappings in a cache (e.g., cache 125 of FIG. 1). At operation 325, the non-routable cloud simulation system provides a reverse proxy server (e.g., reverse proxy server 135 of FIG. 1) of the non-routable cloud simulation system with access to the configuration mappings stored in the cache. Method 300 continues onto the process at operation 330. At operation 330, the reverse proxy server directs the request to a public cloud instance of the first resource that is running in another portion of the public cloud network, based on the configuration mappings. At operation 335, the reverse proxy server directs return data traffic from the public cloud instance of the first resource back to the service under test in the virtual cloud network.

In some examples, the request includes an HTTP request to a non-routable cloud network instance of the first resource. In some instances, the HTTP request includes a first domain name associated with the non-routable cloud network instance of the first resource, a first client identifier that is associated with the non-routable cloud network, and a first subscription identifier that is associated with the non-routable cloud network. In examples, mapping the non-routable cloud configurations to the public cloud configurations (at operation 310) includes:
(a) mapping the first domain name to a second domain name that is associated with a public cloud instance of the first resource;
(b) mapping the first client identifier to a second client identifier that is associated with the public cloud network; and
(c) mapping the first subscription identifier to a second subscription identifier that is associated with the public cloud network.

In some examples, directing the request and the return data traffic (at operations 330 and 335) include directing the HTTP request to the public cloud instance of the first resource based on the mapping of the non-routable cloud configurations to the public cloud configurations; and directing the return data traffic from the first resource to the service under test in the virtual cloud network; respectively.

FIG. 4 depicts an example method 400 for implementing virtual cloud simulation within another cloud network. In examples, the operations of example method 400 may be performed by a cloud simulation system (e.g., cloud simulation system 205 of FIG. 2). Example methods 300 and 400 of FIGS. 3 and 4 correspond to the example systems 100 and 200 of FIGS. 1 and 2, respectively. Where example method 300 of FIG. 3 (corresponding to example 100 of FIG. 1) is directed to simulation of a non-routable cloud network as a virtual cloud network within a portion of a public cloud network, example method 400 of FIG. 4 (corresponding to example 200 of FIG. 2) is directed to simulation of any suitable cloud network as a virtual cloud network within another cloud network.

In the example method 400 of FIG. 4, at operation 405, a DNS server (e.g., DNS server 220 of FIG. 2) of a cloud simulation system in a first cloud network (e.g., virtual cloud network(s) or first cloud network(s) 240a of FIG. 2) receives a request to access a resource from an application (e.g., application or service under test 245 of FIG. 2) that is running within the first cloud network. In some examples, the first cloud network is a portion of a public cloud network or is a cloud network sharing properties and characteristics with the public cloud network. In examples, the request includes cloud configurations for the resource for a second cloud network. In some instances, the second cloud network is a non-routable cloud network including one of a sovereign cloud network, a secure cloud network, a private cloud network, or an on-premises enclave, each of which is isolated from the public cloud network, public resources, and the Internet. In other cases, the second cloud network is any other cloud network in which the application is intended to be tested. In some examples, the resource includes one of a cloud storage resource, a multi-model database resource, a relational database resource, a non-relational database resource, a secrets storage resource, a monitoring service, an applications insights resource, a log analytics resource, a message queue resource, a communication resource, a website resource, or a networking resource.

At operation 410, a central configuration repository (e.g., central configuration repository 230 of FIG. 2) of the cloud simulation system, in the first cloud network, maps the cloud configurations of the resource for the second cloud network that are identified in the request from the application to cloud configurations of the resource for a third cloud network. In examples, each of the non-routable cloud configurations and the public cloud configurations include a set of configurations including at least one of domain name configuration, client identifier configuration, subscription identifier configuration, subject name configuration, subject certificate configuration, subject alternate name configuration, parity flag configuration, cloud region identifier configuration, resource type identifier configuration, tenant identifier configuration, or VM capacity SKU configuration. Method 400 either continues onto the process at operation 415 or continues onto the process at operation 430.

At operation 415, the cloud simulation system retrieves, from the central configuration repository, configuration mappings from the cloud configurations of the resource for the second cloud network to the cloud configurations of the resource for the third cloud network. At operation 420, the cloud simulation system stores the configuration mappings in a cache (e.g., cache 225 of FIG. 2). At operation 425, the cloud simulation system provides a reverse proxy server (e.g., reverse proxy server 235 of FIG. 2) of the cloud simulation system with access to the configuration mappings stored in the cache. Method 400 continues onto the process at operation 430. At operation 430, the reverse proxy server directs the request to the resource that is running in the third cloud network, based on the configuration mappings. At operation 435, the reverse proxy server directs return data traffic from the resource back to the application in the first cloud network.

In some examples, the request includes an HTTP request to an instance of the resource for the second cloud network. In some instances, the HTTP request includes a first domain name associated with the instance of the resource for the second cloud network, a first client identifier that is associated with the second cloud network, and a first subscription identifier that is associated with the second cloud network. In examples, mapping the cloud configurations of the resource for the second cloud network to the cloud configurations of the resource for the third cloud network (at operation 410) includes:
(a) mapping the first domain name to a second domain name that is associated with an instance of the resource for the third cloud network;
(b) mapping the first client identifier to a second client identifier that is associated with the third cloud network; and
(c) mapping the first subscription identifier to a second subscription identifier that is associated with the third cloud network.

In some examples, directing the request and the return data traffic (at operations 430 and 435) include directing the HTTP request to the instance of the resource for the third cloud network based on the mapping of the cloud configurations of the resource for the second cloud network to the cloud configurations of the resource for the third cloud network; and directing the return data traffic from the resource to the application in the first cloud network; respectively.

While the techniques and procedures in methods 300, 400 are depicted and/or described in a certain order for purposes of illustration, it should be appreciated that certain procedures may be reordered and/or omitted within the scope of various embodiments. Moreover, while the methods 300, 400 may be implemented by or with (and, in some cases, are described below with respect to) the systems, examples, or embodiments 100 and 200 of FIGS. 1 and 2, respectively (or components thereof), such methods may also be implemented using any suitable hardware (or software) implementation. Similarly, while each of the systems, examples, or embodiments 100 and 200 of FIGS. 1 and 2, respectively (or components thereof), can operate according to the methods 300, 400 (e.g., by executing instructions embodied on a computer readable medium), the systems, examples, or embodiments 100 and 200 of FIGS. 1 and 2 can each also operate according to other modes of operation and/or perform other suitable procedures.

As should be appreciated from the foregoing, the present technology provides multiple technical benefits and solutions to technical problems. For instance, provisioning a new cloud network or environment, or an application or service within that cloud network or environment, generally raises multiple technical problems. For instance, one technical problem is that conventionally, applications being launched can only be tested within the launched cloud network for which it is designed, which can lead to errors due to incorrect configuration settings or other interoperability issues. In some cases, the interoperability issues can lead to outages of portions or an entirety of the cloud network. Especially for sovereign cloud networks or secure cloud networks, such outages can be problematic, costly, and can in some cases lead to security issues with respect to data and services within such cloud environments. The present technology provides for virtual cloud simulation within a public cloud network, and, in some cases, for virtual cloud simulation within another cloud network. A cloud simulation system simulates a cloud environment as a virtual cloud environment within another established cloud environment, and provides configuration and interoperability testing and validation within the virtual cloud environment that provides mapping of configuration settings of resources used by an application under test within the virtual cloud environment to configuration settings of the resources within the established cloud environment or a public cloud environment that has been well-tested. From the perspective of the application, the application is running within a particular cloud network (e.g., a non-routable cloud network) and communicates with only applications, services, and resources that are hosted within that particular cloud network. In actuality, the cloud simulation system uses a reverse proxy server to direct data traffic from the application to instances of the resources in the established cloud environment or a public cloud environment, based on configuration mappings.

In this manner, interoperability testing within simulated contexts is facilitated, while enabling verification of configuration values against dynamic environments supported by actual cloud resources. Certainty and reliability of deployments and operations in these settings are also boosted. Additionally, the cloud simulation system averts costly outages by enabling identification and notifying service owners of incorrect configurations prior to full production rollout, thereby enhancing cloud service availability and dependability. That is, the probability of outages from incorrect configuration values is dramatically decreased. Independent validation of configurations can be achieved without the need to create dedicated test suites while allowing interface of the application under test in a virtual setting. This assists teams in preparing to buildout new regions and clouds before those regions are physically built, thus decreasing time to market. For multi-cloud scenarios, the cloud simulation system can simulate an air-gapped environment, enabling services to be deployed and tested in one cloud environment while using resources from another cloud environment, effectively creating a digital twin of one cloud on an existing cloud platform. The simulation of the virtual cloud network avoids the standup and purchasing of physical hardware to mimic real world capabilities.

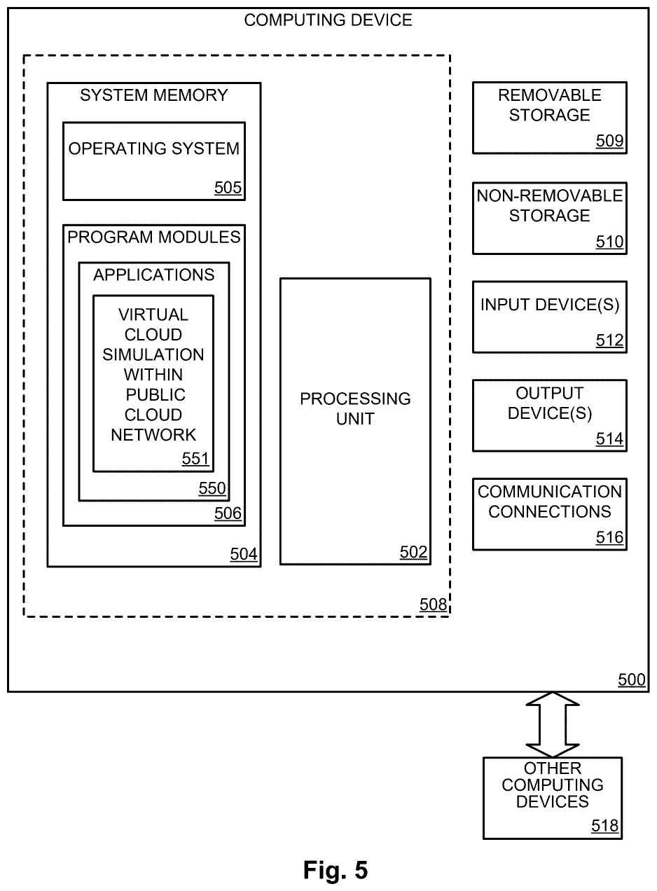

FIG. 5 depicts a block diagram illustrating physical components (i.e., hardware) of a computing device 500 with which examples of the present disclosure may be practiced. The computing device components described below may be suitable for a client device implementing the virtual cloud simulation within a public cloud network. as discussed above. In a basic configuration, the computing device 500 may include at least one processing unit 502 and a system memory 504. The processing unit(s) (e.g., processors) may be referred to as a processing system. Depending on the configuration and type of computing device, the system memory 504 may include volatile storage (e.g., random access memory), non-volatile storage (e.g., read-only memory), flash memory, or any combination of such memories. The system memory 504 may include an operating system 505 and one or more program modules 506 suitable for running software applications 550, such as virtual cloud simulation within public cloud network function 551, to implement one or more of the systems or methods described above.

The operating system 505, for example, may be suitable for controlling the operation of the computing device 500. Furthermore, aspects of the invention may be practiced in conjunction with a graphics library, other operating systems, or any other application program and is not limited to any particular application or system. This basic configuration is illustrated in FIG. 5 by those components within a dashed line 508. The computing device 500 may have additional features or functionalities. For example, the computing device 500 may also include additional data storage devices (which may be removable and/or non-removable), such as, for example, magnetic disks, optical disks, or tape. Such additional storage is illustrated in FIG. 5 by a removable storage device(s) 509 and a non-removable storage device(s) 510.

As stated above, a number of program modules and data files may be stored in the system memory 504. While executing on the processing unit 502, the program modules 506 may perform processes including one or more of the operations of the method(s) as illustrated in FIGS. 3 and 4, or one or more operations of the system(s) and/or apparatus(es) as described with respect to FIGS. 1 and 2, or the like. Other program modules that may be used in accordance with examples of the present disclosure may include applications such as electronic mail and contacts applications, word processing applications, spreadsheet applications, database applications, slide presentation applications, drawing or computer-aided application programs, artificial intelligence (“AI”) applications and machine learning (“ML”) modules on cloud-based systems, etc.

Furthermore, examples of the present disclosure may be practiced in an electrical circuit including discrete electronic elements, packaged or integrated electronic chips containing logic gates, a circuit utilizing a microprocessor, or on a single chip containing electronic elements or microprocessors. For example, examples of the present disclosure may be practiced via a system-on-a-chip (“SOC”) where each or many of the components illustrated in FIG. 5 may be integrated onto a single integrated circuit. Such an SOC device may include one or more processing units, graphics units, communications units, system virtualization units and various application functionalities all of which may be integrated (or “burned”) onto the chip substrate as a single integrated circuit. When operating via an SOC, the functionality, described herein, with respect to generating suggested queries, may be operated via application-specific logic integrated with other components of the computing device 500 on the single integrated circuit (or chip). Examples of the present disclosure may also be practiced using other technologies capable of performing logical operations such as, for example, AND, OR, and NOT, including mechanical, optical, fluidic, and/or quantum technologies.

The computing device 500 may also have one or more input devices 512 such as a keyboard, a mouse, a pen, a sound input device, and/or a touch input device, etc. The output device(s) 514 such as a display, speakers, and/or a printer, etc. may also be included. The aforementioned devices are examples and others may be used. The computing device 500 may include one or more communication connections 516 allowing communications with other computing devices 518. Examples of suitable communication connections 516 include radio frequency (“RF”) transmitter, receiver, and/or transceiver circuitry; universal serial bus (“USB”), parallel, and/or serial ports; and/or the like.

The term “computer readable media” as used herein may include computer storage media. Computer storage media may include volatile and nonvolatile, and/or removable and non-removable, media that may be implemented in any method or technology for storage of information, such as computer readable instructions, data structures, or program modules. The system memory 504, the removable storage device 509, and the non-removable storage device 510 are all computer storage media examples (i.e., memory storage). Computer storage media may include random access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media may be non-transitory and tangible, and computer storage media do not include a carrier wave or other propagated data signal.

Communication media may be embodied by computer readable instructions, data structures, program modules, or other data in a modulated data signal, such as a carrier wave or other transport mechanism, and may include any information delivery media. The term “modulated data signal” may describe a signal that has one or more characteristics that are set or changed in such a manner as to encode information in the signal. By way of example, communication media may include wired media such as a wired network or direct-wired connection, and wireless media such as acoustic, RF, infrared, and other wireless media.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

In this detailed description, for the purposes of explanation, numerous specific details are set forth to provide a thorough understanding of the described embodiments. It will be apparent to one skilled in the art, however, that other embodiments of the present invention may be practiced without some of these specific details. In other instances, certain structures and devices are shown in block diagram form. While aspects of the technology may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the detailed description does not limit the technology, but instead, the proper scope of the technology is defined by the appended claims. Examples may take the form of a hardware implementation, or an entirely software implementation, or an implementation combining software and hardware aspects. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features. The detailed description is, therefore, not to be taken in a limiting sense.

Aspects of the present invention, for example, are described above with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

What is claimed is:

1. A non-routable cloud simulation system, comprising:
resources disposed in a portion of a public cloud network including:
a domain name system (“DNS”) server, the DNS server causing all data traffic from a service under test that is running within the portion of the public cloud network to be routed to the DNS server, wherein the portion of the public cloud network simulates a non-routable cloud network for the service under test, and the data traffic includes non-routable cloud configurations to a resource called by the service under test;
a central configuration repository, the central configuration repository mapping non-routable cloud configurations of the resource identified in the data traffic received from the service under test to public cloud configurations of the resource; and
a reverse proxy server, the reverse proxy server directing the data traffic to a public cloud instance of the resource that is running in another portion of the public cloud network, and that directs return data traffic back to the service under test in the portion of the public cloud network.

2. The non-routable cloud simulation system of claim 1, wherein the non-routable cloud network is one of a sovereign cloud network, a secure cloud network, a private cloud network, or an on-premises enclave, each of which is isolated from the public cloud network, public resources, and the Internet.

3. The non-routable cloud simulation system of claim 1, wherein the resource includes one of a cloud storage resource, a multi-model database resource, a relational database resource, a non-relational database resource, a secrets storage resource, a monitoring service, an applications insights resource, a log analytics resource, a message queue resource, a communication resource, a website resource, or a networking resource.

4. The non-routable cloud simulation system of claim 1, wherein each of the non-routable cloud configurations and the public cloud configurations include a set of configurations including at least one of domain name configuration, client identifier configuration, subscription identifier configuration, subject name configuration, subject certificate configuration, subject alternate name configuration, parity flag configuration, cloud region identifier configuration, resource type identifier configuration, tenant identifier configuration, or virtual machine (“VM”) capacity stock keeping unit (“SKU”) configuration.

5. The non-routable cloud simulation system of claim 1, further comprising:
at least one of a passive monitoring system or an active monitoring system disposed within the portion of the public cloud network, the at least one of the passive monitoring system or the active monitoring system collecting and sending telemetry data to the service under test in the portion of the public cloud network.

6. The non-routable cloud simulation system of claim 1, further comprising:
a cache, which is disposed in the portion of the public cloud network, the cache storing configuration mappings from the non-routable cloud configurations to the public cloud configurations that are retrieved from the central configuration repository and providing the reverse proxy server with access to the configuration mappings; and
a firewall, which is disposed in the portion of the public cloud network, the firewall monitoring the data traffic from the service under test and further directing the data traffic to the DNS server.

7. The non-routable cloud simulation system of claim 1, wherein the data traffic includes a hypertext transfer protocol (“HTTP”) request to a non-routable cloud network instance of a first resource, wherein the HTTP request includes a first domain name associated with the non-routable cloud network instance of the first resource, a first client identifier that is associated with the non-routable cloud network, and a first subscription identifier that is associated with the non-routable cloud network,
wherein mapping the non-routable cloud configurations to the public cloud configurations comprises:
mapping the first domain name to a second domain name that is associated with a public cloud instance of the first resource;
mapping the first client identifier to a second client identifier that is associated with the public cloud network; and
mapping the first subscription identifier to a second subscription identifier that is associated with the public cloud network; and
wherein directing the data traffic and the return data traffic comprise:
directing the HTTP request to the public cloud instance of the first resource based on the mapping of the non-routable cloud configurations to the public cloud configurations; and
directing the return data traffic from the first resource to the service under test in the portion of the public cloud network.

8. A computer-implemented method for establishing a virtual cloud network within a public cloud network to simulate a non-routable cloud network, the computer-implemented method comprising:
receiving, by a domain name system (“DNS”) server in the virtual cloud network and from a service under test that is running within the virtual cloud network, a request to access a first resource, the request including non-routable cloud configurations for the first resource;
mapping, by a central configuration repository in the virtual cloud network, the non-routable cloud configurations of the first resource that are identified in the request from the service under test to public cloud configurations of the first resource;
directing, by a reverse proxy server in the virtual cloud network, the request to a public cloud instance of the first resource that is running in another portion of the public cloud network; and
directing, by the reverse proxy server, return data traffic from the public cloud instance of the first resource back to the service under test in the virtual cloud network.

9. The computer-implemented method of claim 8, wherein the non-routable cloud network that the virtual cloud network is simulating is one of a sovereign cloud network, a secure cloud network, a private cloud network, or an on-premises enclave, each of which is isolated from the public cloud network, public resources, and the Internet.

10. The computer-implemented method of claim 8, wherein the first resource includes one of a cloud storage resource, a multi-model database resource, a relational database resource, a non-relational database resource, a secrets storage resource, a monitoring service, an applications insights resource, a log analytics resource, a message queue resource, a communication resource, a website resource, or a networking resource.

11. The computer-implemented method of claim 8, wherein each of the non-routable cloud configurations and the public cloud configurations include a set of configurations including at least one of domain name configuration, client identifier configuration, subscription identifier configuration, subject name configuration, subject certificate configuration, subject alternate name configuration, parity flag configuration, cloud region identifier configuration, resource type identifier configuration, tenant identifier configuration, or virtual machine (“VM”) capacity stock keeping unit (“SKU”) configuration.

12. The computer-implemented method of claim 8, further comprising:
retrieving, from the central configuration repository, configuration mappings from the non-routable cloud configurations to the public cloud configurations;
storing, in a cache, the configuration mappings; and
providing the reverse proxy server with access to the configuration mappings stored in the cache, the configuration mappings being used by the reverse proxy server to direct the request to the public cloud instance of the first resource.

13. The computer-implemented method of claim 8, further comprising:
monitoring, by a firewall, data traffic from the service under test, the data traffic including the request; and
further directing, by the firewall, the data traffic to the DNS server.

14. The computer-implemented method of claim 8, wherein the request includes a hypertext transfer protocol (“HTTP”) request to a non-routable cloud network instance of the first resource, wherein the HTTP request includes a first domain name associated with the non-routable cloud network instance of the first resource, a first client identifier that is associated with the non-routable cloud network, and a first subscription identifier that is associated with the non-routable cloud network,
wherein mapping the non-routable cloud configurations to the public cloud configurations comprises:
mapping the first domain name to a second domain name that is associated with a public cloud instance of the first resource;
mapping the first client identifier to a second client identifier that is associated with the public cloud network; and
mapping the first subscription identifier to a second subscription identifier that is associated with the public cloud network; and
wherein directing the request and the return data traffic comprise:
directing the HTTP request to the public cloud instance of the first resource based on the mapping of the non-routable cloud configurations to the public cloud configurations; and
directing the return data traffic from the first resource to the service under test in the virtual cloud network.

15. A multi-cloud system, comprising:
a first cloud network simulating a second cloud network for an application that is running within the first cloud network, the second cloud network being a non-routable cloud network, the first cloud network comprising:
a domain name system (“DNS”) server that causes all data traffic from the application to be routed to the DNS server, the data traffic including configurations to a resource for the second cloud network;
a central configuration repository that maps cloud configurations of the resource for the second cloud network that is identified in data traffic received from the application to cloud configurations of the resource for a third cloud network, the third cloud network being a routable cloud network; and
a reverse proxy server that directs the data traffic to an instance of the resource that is running in the third cloud network, and that directs return data traffic back to the application in the first cloud network.

16. The multi-cloud system of claim 15, wherein the non-routable cloud network is one of a sovereign cloud network, a secure cloud network, a private cloud network, or an on-premises enclave, each of which is isolated from a public cloud network, public resources, and the Internet.

17. The multi-cloud system of claim 15, wherein the resource includes one of a cloud storage resource, a multi-model database resource, a relational database resource, a non-relational database resource, a secrets storage resource, a monitoring service, an applications insights resource, a log analytics resource, a message queue resource, a communication resource, a website resource, or a networking resource.

18. The multi-cloud system of claim 15, wherein each of the cloud configurations for the second cloud network and the cloud configurations for the third cloud network include a set of configurations including at least one of domain name configuration, client identifier configuration, subscription identifier configuration, subject name configuration, subject certificate configuration, subject alternate name configuration, parity flag configuration, cloud region identifier configuration, resource type identifier configuration, tenant identifier configuration, or virtual machine (“VM”) capacity stock keeping unit (“SKU”) configuration.

19. The multi-cloud system of claim 15, further comprising at least one of:
at least one of a passive monitoring system or an active monitoring system disposed within the first cloud network, the at least one of the passive monitoring system or the active monitoring system collecting and sending telemetry data to the application in the first cloud network;
a cache, which is disposed in the first cloud network, the cache storing configuration mappings from the cloud configurations for the second cloud network to the cloud configurations for the third cloud network that are retrieved from the central configuration repository and providing the reverse proxy server with access to the configuration mappings; or
a firewall, which is disposed in the first cloud network, the firewall monitoring the data traffic from the application and further directs the data traffic to the DNS server.

20. The multi-cloud system of claim 15, wherein the data traffic includes a hypertext transfer protocol (“HTTP”) request to an instance of the resource for the second cloud network, wherein the HTTP request includes a first domain name associated with the instance of the resource for the second cloud network, a first client identifier that is associated with the second cloud network, and a first subscription identifier that is associated with the second cloud network,
wherein mapping the cloud configurations of the resource for the second cloud network to the cloud configurations of the resource for the third cloud network comprises:
mapping the first domain name to a second domain name that is associated with an instance of the resource for the third cloud network;
mapping the first client identifier to a second client identifier that is associated with the third cloud network; and
mapping the first subscription identifier to a second subscription identifier that is associated with the third cloud network; and
wherein directing the data traffic and the return data traffic comprise:
directing the HTTP request to the instance of the resource for the third cloud network based on the mapping of the cloud configurations of the resource for the second cloud network to the cloud configurations of the resource for the third cloud network; and
directing the return data traffic from the resource to the application in the first cloud network.
